(19) United States
(12) Patent Application Publication
(10) Pub. No.: US 2022/0283878 A1
(43) Pub. Date: Sep. 8, 2022

(54) DEPENDENCY-BASED DATA ROUTING FOR DISTRIBUTED COMPUTING

(71) Applicant: Zapata Computing, Inc., Boston, MA (US)

(72) Inventors: Yudong Cao, Cambridge, MA (US); Eric Reuthe, Franklin, TN (US); Jonathan P. Olson, Medford, MA (US)

(21) Appl. No.: 17/684,343

(22) Filed: Mar. 1, 2022

Related U.S. Application Data
(60) Provisional application No. 63/155,521, filed on Mar. 2, 2021.

(51) Int. Cl. G06F 9/52; G06F 9/48; H04L 45/02

(52) U.S. Cl. CPC G06F 9/52; G06F 9/4881; H04L 45/02

(57) ABSTRACT

A data router receives data from a data source and stores the data in a buffer of the data router. The data router analyzes the data in the buffer to identify the data source. The data router uses a routing map to identify a destination for the data based on the data source and streams the data from the buffer to the destination.

### CROSS REFERENCE TO RELATED APPLICATIONS

This application claims the benefit of U.S. Provisional Application No. 63/155,521, filed Mar. 2, 2021, which is incorporated by reference.

### BACKGROUND

### 1. Technical Field

The subject matter described relates generally to distributed computing and, in particular, to using a data router to stream data to nodes in a distributed computing system.

### 2. Background Information

A workflow can be modeled as a directed acyclic graph between various computational nodes where each directed edge indicates a data source and destination for the data. Workflows distribute a set of tasks across a collection of nodes to parallelize and accelerate execution of the workflow as a whole. These workflows are often carried out in a cloud computing architecture where the computational power can be scaled appropriately to the task at hand. In such architectures, nodes do not have a local shared memory and thus data are typically shared via communication channels. For some workflows (e.g., those involving quantum computers) the amount of data can be large and latencies in the communications channels can become a significant limiting factor on run times.

In typical distributed computing workflows, at least some of the tasks assigned to certain nodes are dependent upon computations performed by other nodes. Thus, the ability to perform a task depends on the exchange of information between nodes. Efficient workflows distribute tasks in a manner that reduces delays due to this communication. To communicate data from one node to another, most computer architectures wait for a task to complete, take the output of the task from memory and write it to disk, and then transmit the output over a communication channel. For tasks involving long processes or large files this can be a significant efficiency hurdle. Nodes that are dependent upon the data generated in the task are held up until this entire process finishes. This problem is particularly notable for workflows using computational nodes that are physically separated (e.g. quantum computers or quantum simulators) or cannot have a shared memory (e.g. where data is maintained locally for confidentiality or security reasons).

### BRIEF DESCRIPTION OF THE DRAWINGS

FIG. 1 is a block diagram of a networked computing environment suitable for providing dependency-based data routing, according to one embodiment.

FIG. 2 is a block diagram of a client device shown in FIG. 1, according to one embodiment.

FIG. 3 is a block diagram of the data router shown in FIG. 1, according to one embodiment.

FIG. 4 is a flowchart of a method for dependency-based routing, according to one embodiment.

FIG. 5 is a block diagram of an optimizer system, according to one embodiment.

FIG. 6 is a block diagram of an optimizer system with multiple sources and plants, according to one embodiment.

FIG. 7 is a block diagram illustrating the use of a data router to add a quantum enhanced optimizer to an existing optimization system, according to one embodiment.

FIG. 8 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Overview

As described previously, in distributed computing environments, certain workflows can suffer from significant latencies, particularly where large amounts of data are to be transferred between different parts to he distributed computing environment. Furthermore, unlike traditional supercomputers that take advantage of high-speed shared memory, distributed computing environments typically lack consistent access to such resources as the computing components performing the tasks in workflows may be separated by significant distances, both physically and in terms of network path lengths/latencies. These and other problems may be addressed by a process and device for dependency-based data routing.

In various embodiments, a task executing on a node produces data that is streamed from memory of the node to a data router as it is produced. The data router may route the streamed data to another node which has a dependency for that data, where the receiving node may then carry out its task as it receives the data. The data routing method may be executed as a monolithic application or set of microservices.

In one embodiment, a computer-implemented method of data routing includes a data router receiving data from a data source and storing the data in a buffer of the data router. The data router analyzes the data in the buffer to identify the data source. The method further includes using a routing map to identify a destination for the data based on the data source and streaming the data from the buffer to the destination.

In some embodiments, the data router is used to add quantum enhanced optimization (“QEO”) or other additional capacity to an existing optimization system. The data router may transparently extract data (e.g., unevaluated and evaluated solutions) from the existing optimization system, provide it to the QEO (or other additional systems) for processing, and inject the results back into the existing optimization system.

### Example Systems

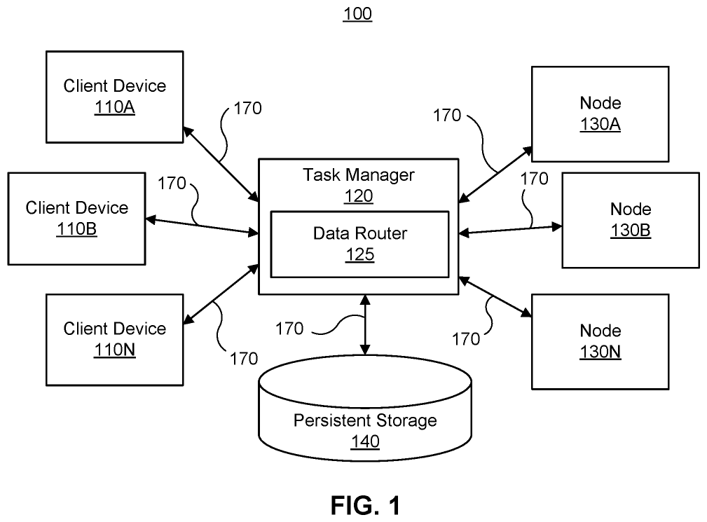

FIG. 1 illustrates one embodiment of a networked computing environment 100 suitable for providing dependency-based data routing. In the embodiment shown, the networked computing environment 100 includes client devices 110, nodes 130, and persistent storage 140, all connected to a task manager 120 via data connections 170. In other embodiments, the networked computing environment 100 includes different or additional elements. In addition, the functions may be distributed among the elements in a different manner than described. For example, although the task manager 120 and persistent storage 140 and are shown as separate components, the corresponding functionality may be provided by a single computing device. Similarly, although three client devices 110A, 110B & 110N and three nodes 130A, 130B & 130N are shown, the networked computing environment 100 may include any number of each type of device. Furthermore, some computing devices may perform the functionality of two or more of a client device 110, a task manager 120, and a node 130 depending on context.

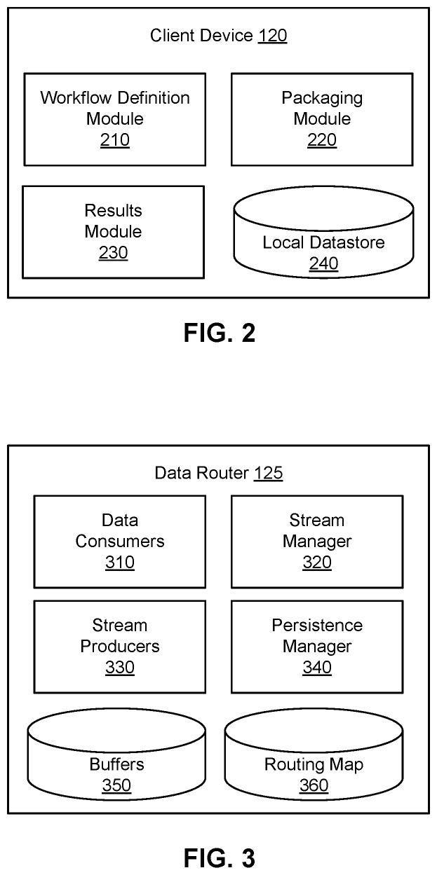

The client devices 110 are computing devices with which users may define and modify workflows as well as review the results generated by workflows. A client device may be any suitable computing device, such as a desktop PC, a laptop, a tablet, a smartphone, or the like. In one embodiment, a client device 110 provides a first user interface for defining a workflow. Once defined, the user may submit the workflow (e.g., via an API) to the task manager 120 for execution. The client device 110 may also provide a second user interface for viewing information about and results generated by the workflow before execution, during execution, on completion, or any combination thereof. For example, the second user interface may provide predictions of when the workflow will be started and completed, preliminary or predicted results while execution is on-going, and final results once the workflow is completed. Various embodiments of client device 110 are described in greater detail below, with reference to FIG. 2.

A node 130 is a physical or virtual machine (or a partition/other division of such a machine) configured to perform one or more tasks within the networked computing environment 100. The nodes 130 may be arranged into pods or clusters spread across multiple physical locations. Different nodes may be optimized or otherwise configured to perform different tasks based on factors including processing power, memory, speed, type (e.g., quantum versus classical), operating system, available software, physical location, and network location, etc. Various tasks may be assigned to nodes 130 by a workflow with at least some of the tasks being dependent of data generated by other tasks in the workflow. For example, the output from a first node 130A may be communicated via a data connection 170 to a second node 130B, which uses the received output in completing one or more tasks. Thus, efficient workflows distribute tasks in a manner that reduces delays due to this communication. In one embodiment, communication delays are reduced by at least some of the nodes 130 streaming data from memory as it is generated rather than waiting to complete a task and then transmitting the generated data (e.g., from disk storage).

The task manager 120 receives workflows from client devices 110 and selects nodes 130 to complete the tasks in those workloads. The task manager 120 may select one or more nodes 130 for each task based on one or more of: the requirements of the task, any dependencies on or by other tasks in the same workload, the properties of the nodes (e.g., type of node, processing power, memory, etc.), the locations of the nodes (e.g., preferentially selecting nodes that are closer together), and the availability of the nodes (e.g., how many other tasks are queued for each node). In one embodiment, the task manager 120 receives workloads via an API and thus the workloads may be independent of the programming language used to define it at a client device 110.

In FIG. 1, the task manager 120 includes a data router 125. Alternatively, the data router may be a separate element in the networked computing environment 100. In either case, the data router 125 receives output from tasks performed by nodes 130 and provides the received output to any nodes assigned tasks that depend on received output using a routing map. In one embodiment, the data router 125 streams received data generated by tasks to any nodes performing other tasks that depend on the received data without waiting for the entire output from the generating tasks. For example, the data router may receive a stream of data generated by a first task executing on a first node 130A, determine that a second task executing on a second node 130B depends on data generated by the first task, and stream the data generated by the first task to the second node without waiting for the first task to be completed. Similarly, the data may be streamed directly from a buffer or other type of memory without writing it to disk or other longer-term storage as an intermediate step. It should be appreciated that this does not mean the data may not also be written to disk or some other form of longer-term storage, but rather that the data is streamed directly from the buffer without being saved to disk as an intermediate step. Various embodiments of the data router 125 are described in greater detail below, with reference to FIG. 3.

The persistent storage 140 includes one or more computer readable media configured to store some or all of the data received by the task manager from nodes 130. In one embodiment, the data router 125 analyzes received data to determine whether it should be stored and, if so, forwards it to the persistent storage 140. For example, the definitions of tasks in a workflow may include a flag or other indicator of whether persistent storage is required. For each data stream, the data router 125 may identify the task that generated the data, check the flag or other indicator for that task in the workflow, and forward the received data to the persistent storage 140 if the flag or other indicator indicates the data should be stored.

The data connections 170 are communication channels via which the other elements of the networked computing environment 100 communicate. The data connections 170 may be provided by a network that can include any combination of local area and wide area networks, using wired or wireless communication systems. In one embodiment, the data connections 170 are part of a network (e.g., the internet) that uses standard communications technologies and protocols. For example, the network can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network may be represented using any suitable format, such as hypertext markup language (HTML) or extensible markup language (XML). In some embodiments, some or all of the communication links of the network may be encrypted using any suitable technique or techniques.

FIG. 2 illustrates one embodiment of a client device 110. In the embodiment shown, the client device 110 includes a workflow definition module 210, a packaging module 220, a results module 230, and a local datastore 240. In other embodiments, the client device 110 includes different or additional elements. In addition, the functions may be distributed among the elements in a different manner than described.

The workflow definition module 210 provides a user interface with which a user can define a workflow. The user interface may be part of an integrated development environment (IDE). In one embodiment, the IDE provides a user interface with which the user can define a directed acyclic graph indicating the relationships and dependencies between tasks in the workflow and provide code modules for performing the tasks in the workflow. The code modules may use any suitable programming language.

The packaging module 220 packages workflows defined using the workflow definition module 210 for submission to the task manager 120. In one embodiment, the packaging module 220 creates a container object including the code and dependencies for the tasks in the workflow. The container object can use a standardized format. The container object can also be configured to provide validation checks and enable workflow scheduling using a standardized approach. The packaging module 220 provides the packaged workflow to the task manager for implementation (e.g., using an API).

The results module 230 provides a user interface with which a user can view information about the workflow after submission to the task manager 120. In one embodiment, the results module 230 receives the results of execution of the workflow after it is complete. The results may be displayed to the user in any suitable format for the particular workflow. Additionally or alternatively, the results module 230 may provide information about the workflow before or during execution. For example, the results module 230 may provide a user interface identifying the nodes 130 that are scheduled to execute or that are currently executing tasks in the workflow along with information such as predicted start and end times for each task. In some embodiments, the results module 230 may enable the user to request that a different node is used for one or more tasks in the workflow. The user interface may also provide preliminary or predicted results of the workflow during execution.

The local datastore 240 is one or more computer-readable medium configured to store the software and data used by the client device 110. In one embodiment, the local data stores includes copies of the workloads created by the user. This may be useful to enable the user to repeat execution of workloads or to restart workloads in the event of a crash or other data loss event at the task manager 120. The local datastore 240 may additionally or alternatively include cached copies of information generated or retrieved by the results module 230 to reduce loading times and network bandwidth requirements.

FIG. 3 illustrates one embodiment of the data router 125. In the embodiment shown, the data router 125 includes one or more data consumers 310, a stream manager 320, one or more stream producers 330, a persistence manager 340, one or more buffers 350, and a routing map 360. In other embodiments, the data router 125 includes different or additional elements. In addition, the functions may be distributed among the elements in a different manner than described. For example, although the routing map 360 is shown as part of the data router 125, in some embodiments, the data router may access the routing map via a data connection 170 from a remote storage location.

The data consumers 310 receive arbitrary streams of incoming data and write them to the buffer 350. Although FIG. 3 shows the buffers 350 as a single entity, each data consumer 310 may have its own buffer. The term buffer 350 is used to mean a memory or portion of memory that allows more rapid read and write operations than long-term storage mediums, such as a hard drive or flash memory.

The stream manager 320 identifies the data in the buffers 350 and uses the routing map 360 to identify one or more destinations for the data. In one embodiment, the stream manager 320 analyzes data received from by a data consumer 310 to identify the source of the data. For example, the stream manager 320 may parse the incoming data stream to identify explicit identification information included in the stream (e.g., in a header portion of data packets in the stream). Explicit identification information may include an identifier of the node 130 from which the stream originates (e.g., a node ID, IP address, or MAC address, etc.) or an identifier of the task that generated the data. Additionally or alternatively, the stream manager 32 may parse the incoming data stream for implicit identifiers of the source. For example, the specific data types or formats included in the stream may originate uniquely from a single node or task. In some instances, the identity of the origin node or task may be irrelevant if the processing instructions can be derived from the format or nature of the data independently from its origin.

Having identified the data, the stream manager 320 uses the routing map 360 identify one or more destinations for the data stream. Data that is needed locally at a future time may be identified to be written to disk, while data which is needed immediately may be identified to be passed to memory. If the data stream is needed at one or more nodes 130, the stream manager uses the routing map 360 to identify one or more channels to which the data will be streamed and notifies one or more corresponding stream producers 330. Note that multiple destinations may be identified for a single data stream and the data may be streamed to each of the destinations simultaneously. In one embodiment, the routing map 360 includes both dependency information for the workflow and infrastructure information indicating properties of the nodes 130 and how to route data to them.

The stream producers 330 stream received data to nodes 130 that are identified as destinations by the stream manager 320. The stream producers 330 may stream data directly from the buffer 350 once the destinations have been determined without waiting for the task generating the data to complete. This can be particularly advantageous with tasks that generate a large amount of data as waiting for all of the data to be received can result in a significant delay in tasks that depend on that data being able to begin. In one embodiment, a stream producer 330 determines the appropriate network protocols and serialization formats for the channel, encodes the data accordingly, and sends the encoded data to the identified destination or destinations. Alternatively, data may be streamed to the destinations in the same format it was received.

The persistence manager 340 manages the storage of data in persistent storage 140. In one embodiment, the destinations identified by the stream manager 320 using the routing map 360 can include persistent storage 340. If persistent storage in an identified destination, the persistence manager 340 saves a copy of the received data from the buffer 30 into persistent storage 140. The data may be stored in conjunction with a timestamp, an identifier of the task that generated it, an identifier of the node 130 that generated it, an identifier of the workflow that generated it, an identifier of the user that created the workflow, or any other desired identifying information. Generally, saving data to persistent storage is lower priority than streaming the data to other destinations, so, unlike the stream producers 330, the persistence manager 340 may wait until all of the data has been received before starting to save it to persistent storage 140. Additionally or alternatively, the persistence manager 340 may compress, encrypt, or otherwise process the data as appropriate for any give use case.

### Example Method

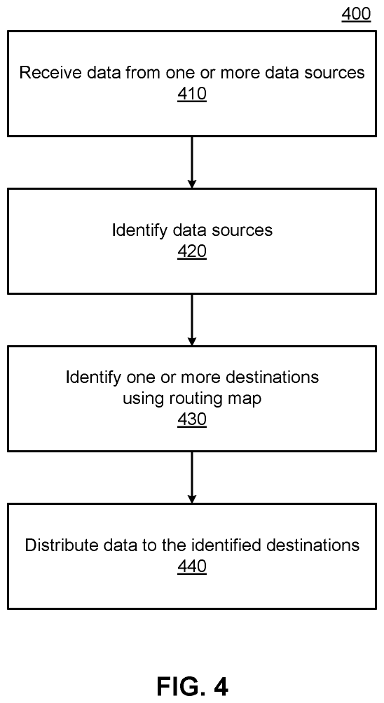

FIG. 4 illustrates a method 400 for dependency-based routing, according to one embodiment. The steps of FIG. 4 are illustrated from the perspective of the data router 125 performing the method 400. However, some or all of the steps may be performed by other entities or components. In addition, some embodiments may perform the steps in parallel, perform the steps in different orders, or perform different steps.

In the embodiment shown in FIG. 4, the method 400 begins with the data router 125 receiving 410 data from one or more sources. The data may be received as one or more arbitrary streams that are stored to a buffer 350. The data router 125 identifies 420 the sources of the data streams. As described previously, the source of a data stream may be determined from an explicit identifier included in the data stream (e.g., in a header portion of data packets in the stream) or implicit identifiers, such as a type or format of the data.

The data router 125 identifies 430 one or more destinations for the received data using the routing map 360. In one embodiment, the routing map 360 includes both dependency information from the corresponding workflow and infrastructure information regarding the network topology and properties of the nodes 130. Thus, having determined the source of received data, the data router 125 can identify one or more nodes 130 that are executing or will execute tasks that depend on the received data and determine how to route the data to the identified nodes. The data router 125 distributes 440 the data to the identified destinations (e.g., by saving the data to local storage, streaming the data to other nodes 130, sending the data to persistent storage 140, or any combination thereof).

### Example Use Case

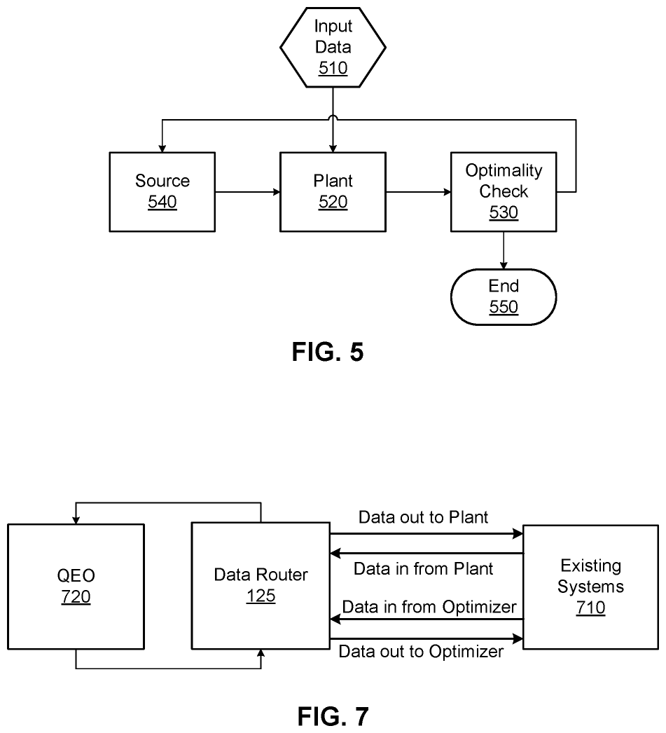

FIGS. 5 through 7 illustrate various embodiments of an exemplary use case of a data router 125. Optimization problems may be solved using one or more plants that receive input data (an unevaluated solution) and produce an output quality metric of the input. The combination of the unevaluated solution and its quality metric as produced by the plant is called an evaluated solution. An optimization problem seeks a solution that maximizes the quality metric. Often this is done by attempting repeatedly various unevaluated solutions until one that yields a satisfactory quality metric, as judged by an optimality check, is found. Quantum enhanced optimization (“QEO”) is a technique of using a quantum computer in conjunction with a classical optimizer system to improve the optimization process. However, many users have existing optimizer systems that do not natively support QEO or have otherwise limited capacity. The techniques disclosed herein enable a data router 125 to be used to add QEO and/or additional capacity to existing optimizer systems with little or no modification of the existing optimizer systems themselves.

FIG. 5 illustrates one embodiment of an optimizer system. In the embodiment shown, input data 510 (an initial unevaluated solution) is provided to a plant 520, which evaluates the initial unevaluated solution to generate a quality metric. An optimality check 530 is performed on the quality metric. Assuming that the quality metric does not meet one or more criteria defined in the optimality check 530, the evaluated solution is passed to a source 540, which generates a new unevaluated solution for the plant 520 to evaluate. This process continues until the quality metric of an evaluated solution meets the criteria of the optimality check 530 (e.g., exceeding a threshold, changing by less than a threshold amount relative to a previous evaluated solution, improving on the quality metric generate for the initial unevaluated solution by at least a certain percentage, or any combination thereof, etc.). Once the criteria are met, the process may end 550 and the solution provided to the user or another process for use. Alternatively, the solution may be outputted but the process may continue evaluating solutions to search for one with an even better quality metric.

Thus, an optimizer in this setting is a source of new unevaluated solutions which are generated based on previous observations of evaluated solutions. Typically, the optimization happens in a sequential fashion, alternating between the plant 520 and the source 540 where the plant generates an evaluated solution, followed by a source proposing a new unevaluated solution, which is then fed to the plant for evaluation. The plant 520 then generates the evaluated solution, and the cycle continues. However, in one embodiment, a streaming approach is used, where the plant 520 keeps taking unevaluated solutions and producing evaluated ones, while the source 540 keeps producing new unevaluated solutions while receiving evaluated ones.

In some embodiments, at least one of the plant 520 and the source 540 uses quantum computation. A plant may use quantum computation by executing a set of quantum circuits as part of its process for evaluating the quality metric of the input (unevaluated solution). For example, and plant 520 may use a variational quantum eigensolver (VQE). In this example, the input is a set of (classical) parameters for the quantum circuit while the output is the estimated expectation of the observables, which involves running quantum circuits on a quantum computer backend. A source may use quantum computation by executing a set of quantum circuits as part of a process for generating new unevaluated solutions based on the input evaluated solutions. An example is a quantum generative model such as a quantum circuit Born machine (QCBM) or a hybrid quantum-classical generative adversarial network, where the quantum computer supplies the source of randomness that enables the generation of new unevaluated solutions.

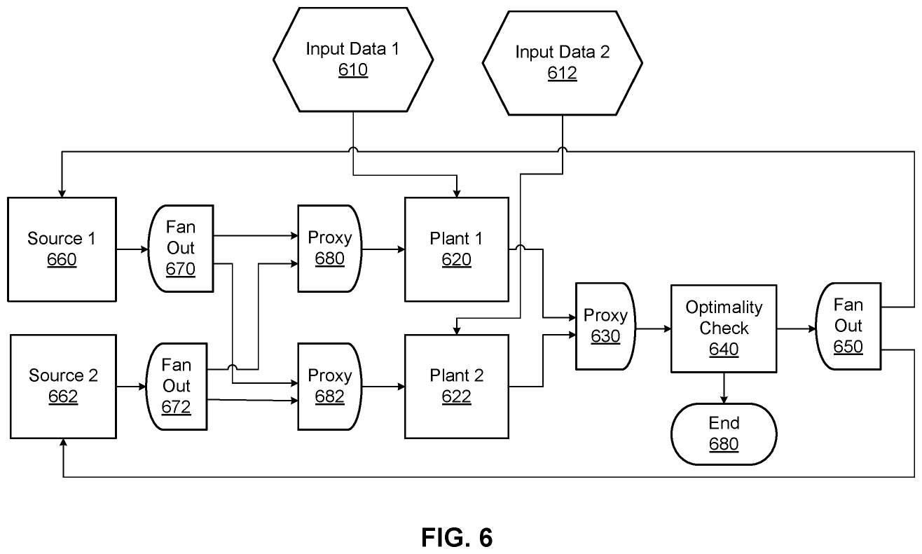

FIG. 6 illustrates a more complex optimizer system with two sources and plants. It should be appreciated that this principle can be extended to any number of plants and sources. In the embodiment shown, the optimizer system includes first input data 610 and second input data 612 that provide initial unevaluated solutions to a first plant 620 and a second plant 622, respectively. The first plant 620 and the second plant 622 evaluate the corresponding solutions to generate quality metrics, which are provided to an optimality check 640 via a first proxy 630. Assuming that the quality metrics do not meet the criteria of the optimality check 640, the evaluated solutions are provided to a first source 660 and a second source 662 via a fan-out operation 650.

The first source 660 and the second source 662 generate new unevaluated solutions using the evaluated solutions which are both passed to the first and second plants 620, 622 via corresponding fan-out operations 670, 672 and proxies 680, 682. The new unevaluated solutions are evaluated by the plants 620, 622 and passed to the optimality check 640 via the proxy 630 and the process repeats until a solution is found that meets the criteria of the optimality check. Similar to the optimization system shown in FIG. 5, once a solution is found that meets the criteria, the process may end 680 or the process may continue searching for further improved solutions.

The plants 620, 622 may be running different or identical evaluation routines, Similarly, the sources 660, 662 may use different or identical optimizers. In the case of VQE, a classical black-box optimization program may be used as a single source with multiple plants each running quantum circuits and measuring different Pauli operators in the Hamiltonian whose ground state is sought. In the case of QEO, where the quantum generative model serves as a “booster” to a classical optimizer, there may be a single plant evaluating the quality of a solution and multiple sources, some of which are running the quantum generative model while others are running a classical optimizer.

FIG. 7 illustrates the use of a data router 125 to add a quantum enhanced optimizer to an existing optimization system 710, according to one embodiment. The existing system 710 can include any combination of sources, plants, and optimality checks, etc. In the embodiment shown, the data router 125 acts as both a proxy and a data stream duplicator, accepting unevaluated data from the QEO 720 and optimizer of the existing 710 and evaluated data from the plant of the existing system. The data router 125 also sends a copy of the evaluated data to both the optimizer of the existing system 710 and the QEO 720. The QEO 720 applies quantum computing techniques to learn the distribution of evaluated of solutions and identify likely new good solutions based on the distribution, which are fed back into the existing optimization system 710.

The default routing of data may be altered through a new routing map 360 provided by the data router 125 or an external data mapping service. Because the data router 125 is only extracting information that the existing optimization system 710 is already generating and routing between components and injecting back in evaluated and/or unevaluated solutions in the same format used by the existing optimization system, the QEO 720 can essentially be added transparently. The existing optimization system 710 continues to operate as it did previously and simply receives additional solutions to process. One of skill in the art will recognize that similar techniques may be used to transparently add additional source and plants of different types to an existing optimization system 710 with minimal or no alteration to the existing system.

### Computing System Architecture

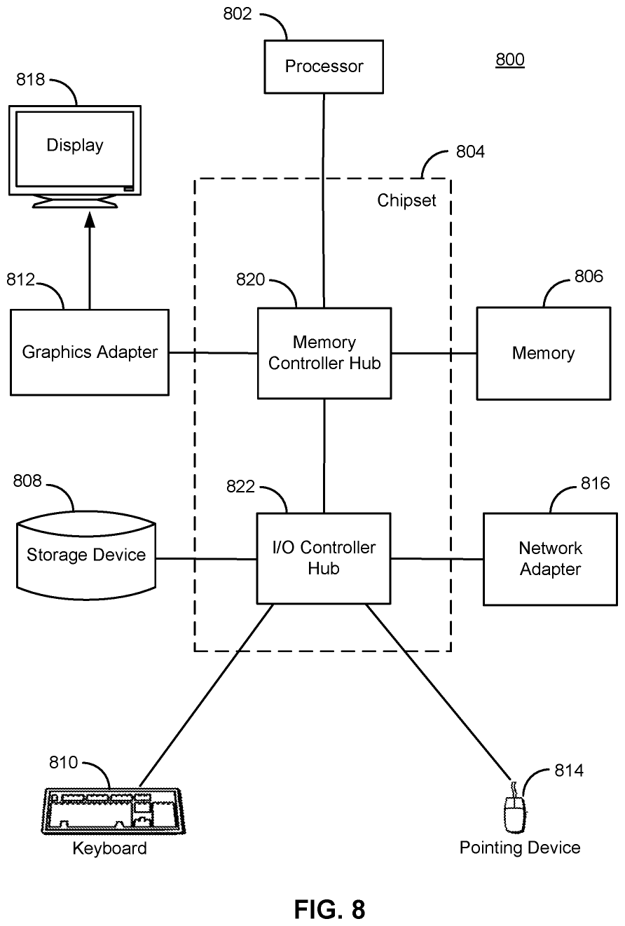

FIG. 8 is a block diagram of an example computer 800 suitable for use as a client device 110, task manager 120, or node 130. The example computer 800 includes at least one processor 802 coupled to a chipset 804. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, keyboard 810, pointing device 814, and network adapter 816 are coupled to the I/O controller hub 822. Other embodiments of the computer 800 have different architectures.

In the embodiment shown in FIG. 8, the storage device 808 is a non-transitory computer-readable storage medium such as a hard drive, compact disk read-only memory (CD-ROM), DVD, or a solid-state memory device. The memory 806 holds instructions and data used by the processor 802. The pointing device 814 is a mouse, track ball, touch-screen, or other type of pointing device, and may be used in combination with the keyboard 810 (which may be an on-screen keyboard) to input data into the computer system 800. The graphics adapter 812 displays images and other information on the display 818. The network adapter 816 couples the computer system 800 to one or more computer networks.

The types of computers used by the entities of FIGS. 1-3 and 5-7 can vary depending upon the embodiment and the processing power required by the entity. For example, persistent storage 140 might include multiple blade servers working together to provide the functionality described. Furthermore, the computers can lack some of the components described above, such as keyboards 810, graphics adapters 812, and displays 818.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for efficient dependency-based routing that may reduce downtime of nodes 130 or communications lag when implementing distributed workloads. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method of data routing, the method comprising:
receiving, by a data router, data from a data source;
storing the data in a buffer of the data router;
analyzing, by the data router, the data in the buffer to identify the data source;
using a routing map to identify, based on the data source, a destination for the data; and
streaming, by the data router, the data from the buffer to the destination.

2. The computer-implemented method of claim 1, wherein identifying the data source comprises parsing the data for identifying information of the data source.

3. The computer-implemented method of claim 2, wherein the identifying information is an explicit identifier and includes at least one of a node ID, an IP address, a MAC address, or an identifier of a task that generated the data.

4. The computer-implemented method of claim 2, wherein the identifying information is an implicit identifier and includes at least one of a type of the data or a format of the data.

5. The computer-implemented method of claim 1, wherein the routing map includes dependency data indicating a task that depends on the data, and the destination is a node scheduled to execute the task.

6. The computer-implemented method of claim 5, wherein the routing map further includes network topology information that indicates a route for sending the data to the node scheduled to execute the task.

7. The computer-implemented method of claim 1, wherein the destination is one of a plurality of destinations for the data, and the data is simultaneously streamed to each of the plurality of destinations.

8. The computer-implemented method of claim 1, wherein a first portion of the data is streamed to the destination before a second portion of the data is received by the data router.

9. The computer-implemented method of claim 1, wherein the data is streamed directly from the buffer without being saved to longer-term storage as an intermediate step.

10. The computer-implemented method of claim 1, wherein the data source is part of an existing optimization system, the destination is a quantum enhanced optimizer (“QEO”), and receiving the data comprises transparently extracting the data from the existing optimization system, the method further comprising injecting an output of the QEO into the existing optimization system.

11. A non-transitory computer-readable medium comprising executable computer program code for data routing, the executable computer program code, when executed by a data router, causing the data router to perform operations including:
receiving data from a data source;
storing the data in a buffer of the data router;
analyzing the data in the buffer to identify the data source;
using a routing map to identify, based on the data source, a destination for the data; and
streaming the data from the buffer to the destination.

12. The non-transitory computer-readable medium of claim 11, wherein identifying the data source comprises parsing the data for identifying information of the data source.

13. The non-transitory computer-readable medium of claim 12, wherein the identifying information is an explicit identifier and includes at least one of a node ID, an IP address, a MAC address, or an identifier of a task that generated the data.

14. The non-transitory computer-readable medium of claim 12, wherein the identifying information is an implicit identifier and includes at least one of a type of the data or a format of the data.

15. The non-transitory computer-readable medium of claim 11, wherein the routing map includes dependency data indicating a task that depends on the data, and the destination is a node scheduled to execute the task.

16. The non-transitory computer-readable medium of claim 11, wherein the routing map further includes network topology information that indicates a route for sending the data to the node scheduled to execute the task.

17. The non-transitory computer-readable medium of claim 11, wherein the destination is one of a plurality of destinations for the data, and the computer program code, when executed by the data router, causes the data router to simultaneously stream the data to each of the plurality of destinations.

18. The non-transitory computer-readable medium of claim 11, wherein the computer program code, when executed by the data router, causes the data router to stream a first portion of the data to the destination before a second portion of the data is received by the data router.

19. The non-transitory computer-readable medium of claim 11, wherein the computer program code, when executed by the data router, causes the data router to stream the data directly from the buffer without saving the data to longer-term storage as an intermediate step.

20. The non-transitory computer-readable medium of claim 11, wherein the data source is part of an existing optimization system, the destination is a quantum enhanced optimizer (“QEO”), and receiving the data comprises transparently extracting the data from the existing optimization system, the operations further comprising injecting an output of the QEO into the existing optimization system.
